(19) United States
(12) Patent Application Publication
(10) Pub. No.: US 2014/0052454 A1
(43) Pub. Date: Feb. 20, 2014

(54) METHOD FOR DETERMINING FORMAT OF LINEAR PULSE-CODE MODULATION DATA

(71) Applicant: MStar Semiconductor, Inc., Hsinchu (TW)

(72) Inventor: CHU-FENG LIEN, Zhubei City (TW)

(21) Appl. No.: 13/943,975

(22) Filed: Jul. 17, 2013

(30) Foreign Application Priority Data
Aug. 14, 2012 (TW) 101129426

(51) Int. Cl. G10L 19/00

(52) U.S. Cl. CPC G10L 19/00
USPC 704/500

(57) ABSTRACT

A method for determining a data format of linear pulse-code modulation is provided. The method includes steps of reading a plurality of bytes of the linear pulse-code modulation data; obtaining a data property by performing a predetermined calculation on the plurality of bytes; and determining the data format of the linear pulse-code modulation data according to the data property.

### FIELD OF THE INVENTION

The present invention relates to a method for determining a data format of linear pulse-code modulation data, and more particularly to a method for determining a data format of linear pulse-code modulation data according to a data property of the linear pulse-code modulation data.

### BACKGROUND OF THE INVENTION

Sound quality of pulse-code modulation data, as being uncompressed, is better than that of an ordinary digital compressed audio file such as a common MEPG Audio Layer III (MP3) file.

According to different sampling intervals, pulse-code modulation data may be categorized into having linear and non-linear pulse-code modulation formats. The former is referred to as linear pulse-code modulation, which samples analog audio signals to be encoded at a constant sampling interval. The latter is referred to as non-linear pulse-code modulation, which employs different sampling intervals. More specifically, non-linear pulse-code modulation logarithmically determines sampling intervals, with a sampling step being more dispersed as an electric potential gets higher and denser as an electric potential gets lower. Sound quality rendered by non-linear pulse-code modulation is better when original audio data sampled are largely low-potential signals.

Different types of pulse-code modulation data are expressed in data formats of audio information, whereas details, e.g., a sampling frequency, of audio data are not standardized as in MP3 and WAV formats. Thus, errors may occur when playing pulse-code modulation audio data stored in regardless the linear or non-linear pulse-code modulation format.

Take linear pulse-code modulation for example. A set of audio data encoded by linear pulse-code modulation is usually represented in a bit format of a byte that is a multiple of 16 bits, 24 bits or 32 bits. However, complications in data processing are frequently incurred when a byte is adopted as a basic unit in audio data processing due to endianness inconsistency.

In short, the issue of endianness is resulted by different audio data formats. When an audio data format is determined incorrectly, a predetermined playback format at a playback end is inconsistent with a placement of an inputted pulse-code modulation data format, such that the linear pulse-code modulation audio data cannot be correctly read and noises may be then be generated and outputted.

An example of an endianness issue is given below. Assume that data of four consecutive characters 0, 1, 2 and 3 are expressed in a binary format. The data of the four characters are expressed as 00000000, 00000001, 00000010 and 00000011. When storing the four sets of data, memory spaces of four consecutive addresses are required. Yet, actual placement formats of the four sets of data in the four addresses of the memory spaces may differ according to whether a system adopts a big endian or a little endian.

Assume that the four characters are stored according to a word-oriented big endian format, the four sets of data are stored as: 00000000-00000001-00000010-00000011. That is, data of most significant bits are correspondingly stored at lower addresses. In contrast, assume that a byte-oriented little endian format is adopted, data of least significant bits are stored at lower addresses in the memory spaces. Therefore, with the little endian format, the data sequence stored in the memory spaces is: 00000011-00000010-00000001-00000000. As endianness may affect whether data are correctly read, data contents can incorrectly read when formats of written data and read data are defined inconsistently.

FIG. 1 shows a schematic diagram of a data sequence stored in a memory according to different endian formats. Assume that read data contents are 0x12345678, the data 0x12, 0x34, 0x56, 0x78 are sequentially stored from a low address to a high address if a processor using a big endian by MIPS Technologies is adopted. As the data are stored in such sequence into a memory device, e.g., an optical disk, a sequence of the data contents read by an Intel processor using a little endian when reading the stored data is 0x78, 0x56, 0x34 and 0x12, meaning that the data contents are incorrectly read.

The above issue is usually treated by a commonly accepted conventional solution. For example, when a system utilizes a big endian for a storage format, all linear pulse-code modulation data are played by a big endian format when accessing data. However, the above conventional solution contains risks of incorrectly reading the data format. More particularly, in an environment of different data formats of data from diversified sources under the prevalence of the Internet, playback malfunctions caused by incorrectly reading formats of stored data are rather frequent. Therefore, there is a need for a solution for a method for correctly determining a format of stored data for linear pulse-code modulation.

### SUMMARY OF THE INVENTION

Therefore, the object of the present invention is to provide a method for determining a data format of linear pulse-code modulation data. The linear pulse-code modulation data are obtained via a network stream or provided by a storage device. The method includes steps of reading a plurality of bytes of the linear pulse-mode modulation data; obtaining a data property by performing a predetermined calculation on the plurality of bytes; determining the data format of the linear pulse-code modulation data according to the data property, e.g., a big endian or a little endian; converting the linear pulse-code modulation data to a predetermined data format in response to a result of the determining step; and storing the linear pulse-code modulation data in the converted predetermined data format. The reading step may set a reading period and read the bytes of the linear pulse-code modulation data within the reading period. The predetermined calculation may sum squared differences of the bytes or sum absolute values of differences of the bytes. Assume that the linear pulse-code modulation data are stored in a storage unit of 16 bits. The step of obtaining the data property may read a first byte and a second byte from the bytes; and perform the predetermined calculation on the first byte and the second byte.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 shows a data sequence stored to a memory when different bit sequence formats are utilized.

FIG. 2 is flowchart of a method for determining a data format according to an embodiment of the present invention.

FIG. 3 is a system block diagram in an actual application according to an embodiment of the present invention.

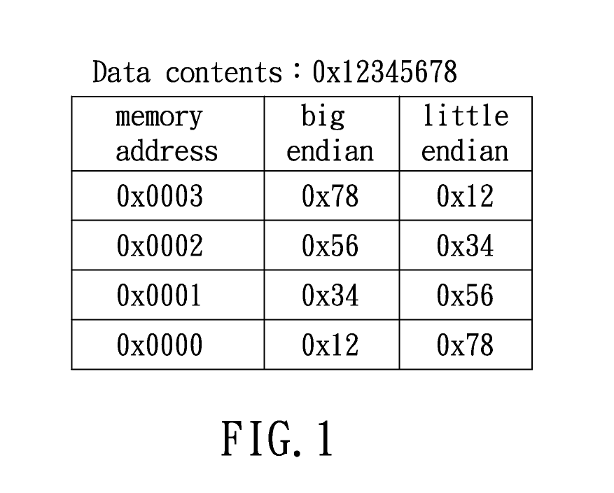

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

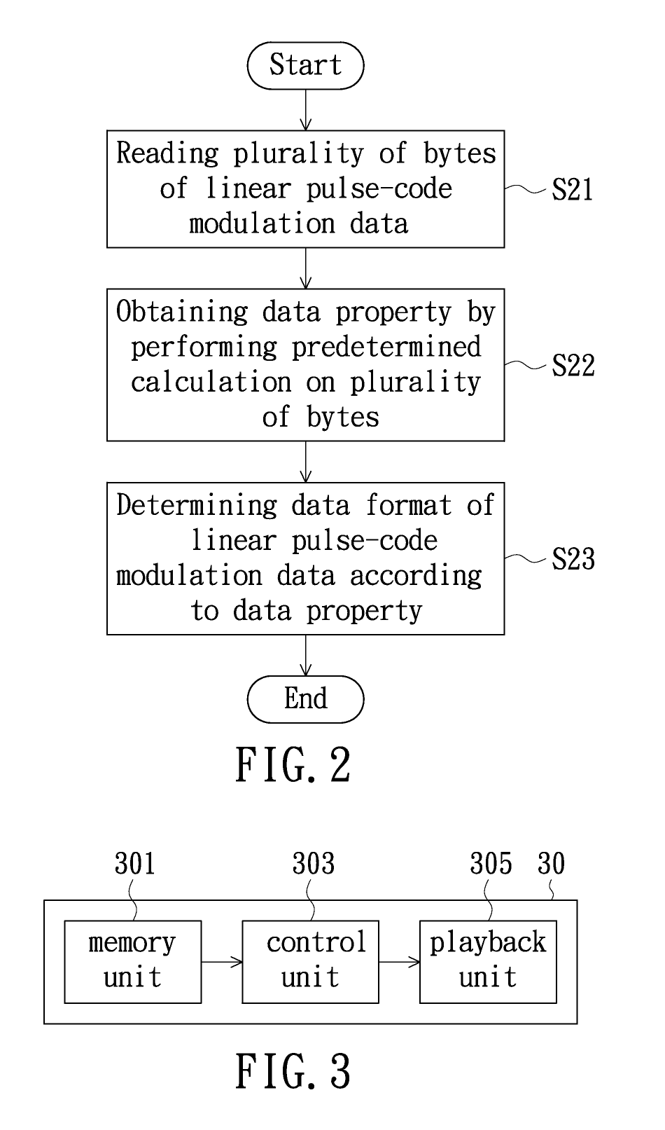

FIG. 2 shows a flowchart of a method for determining a data format according to an embodiment of the present invention, including the following steps.

In step S21, a plurality of bytes of the linear pulse-code modulation data are read. In step S22, a predetermined calculation is performed on the data of the read bytes, and a data property of the linear pulse-code modulation data is obtained by the predetermined calculation. In step S23, according to the data property obtained by a result of the predetermined calculation, it is determined whether the data format of the linear pulse-code modulation data is a big endian or a little endian.

In this embodiment, a source providing original audio data may be a file from non-volatile storage device such as an optical disk, a hard drive or a flash memory, or may be a data stream received from the Internet. Regardless of the file or the audio data stream, the endian utilized by the linear pulse-code modulation data from the same source is consistent. Therefore, a portion of bytes of the linear pulse-code modulation data are selected, and the data property determined according to the selected bytes represents the data format property of all the audio data.

Preferably, when reading the plurality of bytes in step S21, in addition to setting a threshold as a byte count, e.g., 20 bytes, for data reading, a reading period, e.g., one second, may also be set during system configuration. According to the length of the reading period, the plurality of bytes of the linear pulse-code modulation data are read within the reading period.

To represent audio data with minimal distortion, linear pulse-code modulation data are commonly sampled at audio sampling frequencies such as 48 kHz and 44.1 kHz to obtain continuous audio data. Thus, under the premise that continuous linear pulse-code modulation data are correlated in numerical continuity with a negligible difference, values of LPCM1 and LPCM2 obtained at two consecutive time points t1 and t2 have a small difference when the linear pulse-code modulation data are continuously observed at the two time points t1 and t2. According to a concept of the present invention, a predetermined calculation method is developed based on the above data property. Hence, when reading data, the data property of the linear pulse-code modulation data to be read can be obtained by performing the predetermined calculation.

In other words, with respect to linear pulse-code modulation data expressed in a correct format, contents of a particular set of data and several sets of preceding and following data of the linear pulse-code modulation data are in fact quite similar. In the event of an incorrect format of read data due to incorrectly reading an endian when reading the data, the linear pulse-code modulation data appears as discontinuous.

Assume that contents of four consecutive sets of linear pulse-code modulation data to be read are respectively 0xAA11, 0xAA12, 0xAA13 and 0xAA14. When the above data are read according to a correct endian, data contents 0xAA11, 0xAA12, 0xAA13 and 0xAA14 are correctly obtained. However, when the above data are read according to an incorrect endian, a sequence of the data actually read is 0x11AA, 0x12AA, 0x13AA and 0x14AA. By comparing the read data, values of the sets of data in the result obtained according to the correct endian are smaller than values of the second group. For example, 0xAA11 and 0xAA12 differ by 0x1, i.e., 1 of a decimal format, whereas 0x12AA and 0x11AA differ by 0x100, i.e., equal to 256 of a decimal format. Differences of the remaining sets of data have similar feature.

As previously described, in step S22, the data property is obtained by performing the predetermined calculation on the read bytes. Taking 16-bit linear pulse-code modulation data for example. Step S22 includes: reading a first byte and a second byte from the plurality of bytes; and performing the predetermined calculation on the first byte and the second byte. For example, the predetermined calculation may be different calculation methods, e.g., calculating a sum of squared differences or a sum of absolute values of differences to obtain a sum of absolute values of the differences.

The same predetermined calculation is then similarly performed on other bytes of the read bytes. For example, when a selected calculation method is obtaining the difference of squares of two bytes, the difference of squares of the second byte and a third byte, the difference of squares of the third byte and a fourth byte, the difference of squares of the fourth byte and a fifth byte, and so forth, are calculated using the same approach. After obtaining all the differences of the squares, a sum and/or an average is obtained.

FIG. 3 shows a video/audio playback device 30. Original linear pulse-code modulation data obtained are provided to a control unit 30 by a memory unit 301, and the predetermined calculation is performed by the control unit 303 to determine and convert the linear pulse-code modulation data. After the control unit 303 provides a determination result, a playback unit 305 directly plays the data in the converted endian, or stores the converted data in the converted endian back to the memory 301 for following process of audio playback of the video/audio playback device 30.

When the present invention is implemented via an application on a personal computer, a user may select a data format to be converted, and may convert a file in an original format unsupported by the video/audio playback device to an endian format supported by the video/audio playback device by executing corresponding software. After converting the linear pulse-code modulation data to a predetermined data format, apart from directly playing the linear pulse-code modulation data through software, the personal computer may also store the converted linear pulse-code modulation data as a converting medium of the linear pulse-code modulation data for further process.

Assume that a video/audio playback device of a user supports files stored in a big endian storage format. By using an application, the data stored in a little endian storage format are automatically determined and converted into a big endian data form a, and the audio data converted to the big endian data format are then stored in a portable disk. By connecting the portable disk to a video/audio playback device, the video/audio playback device is allowed to correctly read the audio data already converted to the big endian for normal audio playback.

By automatically determining the linear pulse-code modulation data and converting the linear pulse-code modulation data to a predetermined data format, e.g., the big endian format in the foregoing embodiment, the converted linear pulse-code modulation data may be stored according to different destinations, or the linear pulse-code modulation data converted to a predetermined format may be directly played.

Assume that contents of a part of a series of linear pulse-code modulation data are: 0xFE6A FE63 FF80 0005 FED9 FC86 00A1 00C4 FED2 FFEC 011F 0048 0099 01A2. By performing a predetermined calculation on the foregoing 14 bytes, 13 differences between every two bytes can be obtained. The 13 differences are squared, summed, and averaged, by dividing by 13, and square roots are calculated to obtain a predetermined calculation result Rb when sequencing by a big endian, and a predetermined calculation result Rl when sequencing by a little endian.

The calculation result Rb when sequencing by a big endian is:

Rb=SQRT(((0xFE6A−0xFE63)̂2+(0xFE63−0xFF80)̂2+(0xFF80−0x0005)̂2+(0x0005−0xFED9)̂2+(0xFED9−0xFC86)̂2+(0xFC86−0x00A1)̂2+(0x00A1−0x00C4)̂2+(0x00C4−0xFED2)̂2+(0xFED2−0xFFEC)̂2+(0xFFEC−0x011F)̂2+(0x011F−0x0048)̂2+(0x0048−0x0099)̂2+(0x0099−0x01A2)̂2)/13).

The calculation result Rl when sequencing by a little endian is:

Rl=SQRT(((0x6AFE−0x63FE)̂2+(0x63FE−0x80FF)̂2+(0x80FF−0x0500)̂2+(0x0500−0xD9FE)̂2+(0xD9FE−0x86FC)̂2+(0x86FC−0xA100)̂2+(0xA100−0xC400)̂2+(0xC400−0xD2FE)̂2+(0xD2FE−0xECFF)̂2+(0xECFF−0x1F01)̂2+(0x1F01−0x4800)̂2+(0x4800−0x9900)̂2+(0x9900−0xA201)̂2)/13).

When the calculation results Rb<Rl, it indicates that the values have smaller variances when sequencing by the big endian. It is determined that the linear pulse-code modulation data utilize a large endian format. Thus, in subsequent playback, the data need not be converted if a system adopts a large endian processing format. Further, when a system adopts a small endian processing format as a predetermined format, all the linear pulse-code modulation data need be first converted from the big endian format to the small endian format in order to be correctly played. Since data of a same group have a same format when transmitted, the above operation only needs to check an initial part of the linear pulse-code modulation data, and so no negative effects are introduced as far as real-time playback applications are concerned.

Alternatively, other operation approaches capable of emphasizing variances among the different sets of data can also be applied as the predetermined calculation. For example, differences between every two sets of data are calculated, and absolute values of the differences are calculated for the predetermined calculation. Based on the continuity property of linear pulse-code modulation data, differences between every two bytes expressed in a correct format are relatively smaller. For example, for a data format originally expressed by a little endian, a sum of absolute values of differences calculated by a little endian is smaller than a sum of absolute values of differences calculated by a big endian. Accordingly, it can be determined that the linear pulse-code modulation data represented by the audio data are in a small endian format.

Again taking the contents of foregoing series of linear pulse-code modulation data for example, the predetermined calculation result Rb ordering by a big endian is:

Rb=|0xFE6A−0xFE63|+|0xFE63−0xFF80|+|0xFF80−0x0005|+|0x0005−0xFED9|+|0xFED9−0xFC86|+|0xFC86−0x00A1|+|0x00A1−0x00C4|+|0x00C4−0xFED2|+|0xFED2−0xFFEC|+|0xFFEC−0x011F|+|0x011F−0x0048|+|0x0048−0x0099|+|0x0099−0x01A2|.

The calculation result Rl when ordering by a little endian is:

Rl=|0x6AFE−0x63FE|+|0x63FE−0x80FF|+|0x80FF−0x0500|+|0x0500−0xD9FE|+|0xD9FE−0x86FC|+|0x86FC−0xA100|+|0xA100−0xC400|+|0xC400−0xD2FE|+|0xD2FE−0xECFF|+|0xECFF−0x1F01|+|0x1F01−0x4800|+|0x4800−0x9900|+|0x9900−0xA201|.

It should be noted that, the average of sums of squared differences and the sum of absolute values of differences are described by way of examples in the foregoing embodiments. Alternatively, other predetermined calculation approaches may be utilized for determining the correlation of data continuity and for determining whether a sequencing method of data needs to be changed.

Further, the 16-bit linear pulse-code modulation data are taken as an example in the foregoing embodiments. Since the data in a 16-bit format is a multiple of a byte (two sets of 8 bits), the endian format can be determined to be a big endian or a little endian by performing a calculation on every two bytes. For the reason that the linear pulse-code modulation data in a unit of other bit count also has a similar property of two consecutive sets of continuous data, the present invention may be also be implemented to various types of linear pulse-code modulation data that are stored in a storage unit of a different bit count.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for determining a data format, applied to linear pulse-code modulation data, comprising:
reading a plurality of bytes of the linear pulse-code modulation data;
obtaining a data property by performing a predetermined calculation on the plurality of bytes; and
determining the data format of the linear pulse-code modulation data according to the data property.

2. The method according to claim 1, wherein the reading step comprises:
setting a reading period; and
reading the plurality of bytes of the linear pulse-code modulation data within the reading period.

3. The method according to claim 1, further comprising:
converting the linear pulse-code modulation data to a predetermined data format in response to a result of the determining step.

4. The method according to claim 3, further comprising:
storing the linear pulse-code modulation data converted to the predetermined data format.

5. The method according to claim 3, further comprising:
playing the linear pulse-code modulation data converted to the predetermined data format.

6. The method according to claim 1, wherein the predetermined calculation comprises summing squared differences of the plurality of bytes.

7. The method according to claim 1, wherein the predetermined calculation comprises summing absolute values of differences of the plurality of bytes.

8. The method according to claim 1, wherein the data property is a big endian or a little endian.

9. The method according to claim 1, wherein the linear pulse-code modulation data are stored in a storage unit of 16 bits.

10. The method according to claim 1, wherein the step of performing the predetermined calculation on the plurality of bytes comprises:
reading a first byte and a second byte of the plurality of bytes; and
performing the predetermined calculation on the first byte and the second byte.

11. The method according to claim 1, wherein the linear pulse-code modulation data are obtained via a network stream or provided by a storage device.
